(19) United States
(12) Patent Application Publication
(10) Pub. No.: US 2026/0332927 A1
(43) Pub. Date: Oct. 22, 2026

(54) WEARABLE SPEAKER FRAME WITH HAPTIC CANISTERS

(71) Applicant: J Carter Sisney, Santa Barbara, CA (US)

(72) Inventor: J Carter Sisney, Santa Barbara, CA (US)

(21) Appl. No.: 19/651,194

(22) Filed: Apr. 17, 2026

Related U.S. Application Data
(60) Provisional application No. 63/790,865, filed on Apr. 18, 2025.

(51) Int. Cl. H04R 1/02; G08B 6/00; H04R 1/34; H04R 1/40; H04R 3/12

(52) U.S. Cl. CPC H04R 1/026; G08B 6/00; H04R 1/025; H04R 1/345; H04R 1/403; H04R 3/12; H04R 2201/028; H04R 2400/03; H04R 2400/11; H04R 2430/01

(57) ABSTRACT

A portable personal audio frame that combines separately amplified audio and haptic sources for a fuller sound experience and reduced noise emitted to the surroundings. The personal audio frame combines separately amplified audio and haptic sources such as an audio exciter speaker in contact with the chest for a fuller sound experience and reduced noise emitted to the surroundings. Each pair of audio and exciter speakers may be rigidly housed into a single canister unit having power and amplification circuitry for separately activating the two speakers. The canister units are preferably fixed with respect one another a space lateral distance apart via a suspension frame such as a collar that goes around behind the wearer's neck. When the wearer is standing, the weight of the canister units applies downward pressure to chest-contact plates at the bottom of each unit which contact the user's upper-chest cavity area.

### RELATED APPLICATIONS

The present application claims priority to U.S. provisional Ser. No. 63/790,865, filed Apr. 18, 2025, the contents of which are expressly incorporated herein.

### FIELD OF THE INVENTION

The present invention is directed to a wearable personal audio frame that drives haptics and sonic energy into the user's upper chest cavity and outer ears for a more immersive sound experience.

### BACKGROUND OF THE INVENTION

Haptic bass-shaker/vibrator based chest straps, vests, and backpacks from Woojer, Subpac, Basspak, & Backbeat are available, typically for an immersive personal experience, such as when video gaming. These devices do not use acoustic exciters or gravity secured haptic canisters, but instead use rotating magnet motors or “vibrators” that only emulate sonic frequencies, offering only bass emulations and not full range sound, and often have a “lag” effect from this approach. Moreover, the devices typically require straps to stay in position and do not use a wearable frame.

Conversely, sound collars from Sony, Bose, & Kove Konvex are all optimized for comfort and small size which requires them to direct sound upwards from below the ear. These prior designs do not leverage characteristics of the human hearing system and our internal processing of sound, which is aligned in a forward-facing manner (see, e.g., https://tinyurl.com/earfaqs). They also do not have haptic response and in general do not emulate the experience of a soundstage in front of you.

There remains a need for a portable personal audio frame that combines amplified audio and haptic sources for a fuller sound experience and reduced noise emitted to the surroundings.

### SUMMARY OF THE INVENTION

The present application is directed to a wearable personal audio frame that directs sonic energy into the user's upper chest cavity via haptic canisters for a more immersive sound experience. An optional hand-held haptic canister module syncs with the frame and allows for expanded zones of bodily contact with the device. A deluxe model adds two full-range open-air speakers on top of the frame canisters that are each designed to leverage the acoustical properties of the shape of the outer ear.

It is an object of the present application to provide a portable personal audio device that uses a wearable flex-frame design to secure haptic audio canisters directly over the user's upper chest area and offers a hand-held haptic module to effect additional areas of the user's body. The device includes a wearable speaker frame that optionally offers open-air full-range sound in addition to a haptic response, and that offers the user the experience of aiming at a professional PA concert soundstage, though with much less external sound levels to those nearby. The personal audio frame may combine amplified audio and haptic sources such as an audio exciter speaker in contact with the chest for a fuller sound experience.

Each pair of audio and exciter speakers may be rigidly housed into a single canister unit having power and amplification circuitry for separately activating the two speakers. The canister units are preferably fixed with respect one another and spaced a lateral distance apart via a suspension frame such as a collar that goes around behind the wearer's neck. When the wearer is standing, the weight of the canister units applies downward pressure to chest-contact plates at the bottom of each unit which contact the user's upper-chest cavity area.

The personal audio frame may have separate low-frequency audio drivers and controls for adjustment of the felt response that are separate from the main volume controls for the full-range speakers.

The personal audio frame may have wired inputs/outputs, or an optional wired or wireless hand-held exciter module for additional haptic response that allows for targeting of the felt response beyond just the user's upper chest cavity when desired.

The personal audio frame may be mounted on a collar worn around the neck.

The present application describes a wearable frame that is used for personal audio immersion via gravity secured haptic canisters that drive low frequencies below 700 hz into the upper chest cavity of the user, using audio exciters and/or bass subwoofer drivers. Passive radiators may also be used to achieve haptic bass response, and some mini speakers use this technology to get “rumbling bass” response. The basic model frame is designed to be used simultaneously with headphones, while the deluxe model frame has two full-range speakers mounted on top of each haptic canister that direct the full range of audio programming precisely back towards the user's outer ear auris. This results in an immersive open-air listening experience that represents a new class of high fidelity listening device. The wearable frame bridges the gap between listening to a professional PA soundstage concert, and the traditional personal audio device experience such as professional headphones.

Disclosed herein is a portable personal audio device that uses gravity secured haptic canisters to drive low frequencies into the user's upper chest cavity. Optionally, a hand-held version of a haptic canister synchronizes with the frame to allow for targeted haptic response beyond just the user's upper chest area. The deluxe model incorporates open-air speakers that are positioned away from and in front of the user's ears, and that aim full range sound directly back towards each ear auris.

A portable personal audio frame as disclosed herein may place open-air speakers away from and in front of the user's ears, while aiming full range sound directly back towards each ear auris. The frame features a “haptic” design that directs lower frequencies below 700 hz directly into the user's upper chest. Optionally, the hand-held haptic module allows for synchronized lower frequency haptics to be targeted and felt beyond just the upper chest area.

A further understanding of the nature and advantages of the invention will become apparent by reference to the remaining portions of the specification and drawings.

### BRIEF DESCRIPTION OF THE DRAWINGS

Features and advantages of the present invention will become appreciated as the same become better understood with reference to the specification, claims, and appended drawings.

FIG. 1 shows the main frontal/side aspect of a “deluxe” model of the portable personal audio frame, and FIG. 1A schematically illustrates a human figure wearing the deluxe frame.

FIG. 1B schematically shows an alternative support frame for the deluxe personal audio frame as worn by a user.

FIG. 2 shows an exploded view of the deluxe portable personal audio frame, included the internal amplifiers, batteries, and articulating ball joints.

FIGS. 3-5 show the deluxe frame assembly from multiple angles.

FIGS. 6-7 show an exploded view of the left and right-side speaker canister towers and components, including the full range speakers, batteries and exciters.

FIG. 8 shows the main frontal/side aspect of an alternative “basic” portable personal audio frame.

FIGS. 9-10 show an exploded view of left and right-side canister towers and components of the basic frame, including batteries and exciters.

FIGS. 11 and 12 schematically illustrate the targeted area of the upper chest for best haptic response from the secondary low frequency audio for both the deluxe and basic frame models.

FIG. 13 is a frontal view of a user's torso indicating desired placement of chest-contact plates of either of the deluxe or basic frame models.

FIG. 14 shows an optional hand-held haptic module.

FIG. 15 shows a close up of the optional hand-held haptic module.

FIG. 16 shows an exploded view of the optional hand-held module and corresponding components.

FIG. 17 is a parts list with corresponding reference numbers.

FIG. 18 is a perspective view of an alternative portable personal audio frame having left and right-side speaker canister towers but no exciters.

FIG. 19 is an exploded perspective view of the alternative audio frame of FIG. 18.

FIG. 20A is a perspective view of the two speaker canister towers of the alternative audio frame of FIG. 18 showing a pair of sound baffles extended, and FIG. 20B shows the baffles retracted.

FIG. 21 is an exploded perspective view of the two speaker canister towers of the alternative audio frame of FIG. 18.

FIG. 22 is a perspective view of the alternative audio frame of FIG. 18 as positioned on a wearer.

FIGS. 23 and 24 schematically illustrate the targeted area of the upper chest for best audio reception from the speakers in the alternative audio frame seen in FIG. 18.

### DETAILED DESCRIPTION OF THE PREFERRED EMBODIMENTS

The present application is directed to an improved portable personal audio frame that combines separately amplified audio and haptic sources such as an audio exciter in contact with the chest for a fuller sound experience and reduced noise emitted to the surroundings. An audio exciter, used for haptic feedback, generates tactile sensations by vibrating a surface it is attached to, allowing users to feel vibrations or tactile feedback.

The application discloses a new class of battery powered portable personal audio frame that combines two separately amplified audio modalities into a wearable flex-frame design. The wearable flex-frame is designed to secure haptic audio canisters directly over the user's upper chest area. These canisters have been designed to have substantial weight so that the body-contact plates at the bottom of each canister are naturally pressed into the soft tissue of the user without the need for straps or webbing. The result is an easy to use and comfortable device that allows for low-frequencies below 700 hz to be tangibly felt through the user's whole chest cavity, resulting in a richer and fuller sonic listening experience while using headphones, headsets, or external speakers.

The primary sound is dispersed via full-range speakers that are each strategically placed to leverage the shape of the outer ear. Perched just to the sides, and in front of the user's cheek bones, sound energy is aimed & directed back towards each ear auricle to present a front-biased stereo image that is similar to a concert experience while aiming at a soundstage. Removable baffle caps on the speaker face help direct the sound directly to the folds of the ear through the use of a shaped reflector plate. The open-air design allows the user to also hear their surroundings and even to communicate with others freely nearby during use. Moreover, the close proximity to the wearer's ears and directed sound minimizes sound leakage to the surroundings, making the portable personal audio frame much less bothersome to people around the wearer.

A hand-held version of the haptic canister allows for targeting the felt bass sensations to areas of the user's body beyond just the upper chest cavity. Importantly, a deluxe model of the frame adds two full-range speakers on top of the canisters that are each strategically placed to leverage the acoustical properties of the shape of the outer ear. Perched just to the sides, and in front of the user's cheek bones, sound energy is aimed and directed back towards each ear auricle to present a front-biased stereo image that is similar to a concert experience while aiming at a soundstage. Removable baffle caps on each speaker face help direct the sound directly to the folds of the ear through the use of a shaped reflector plate. The open-air design allows the user to also hear their surroundings and even to communicate with others freely nearby during use. A deluxe model frame represents a new class of audio device that bridges the gap between listening to a PA soundstage concert experience and professional headphones.

The haptic canisters themselves are novel, in that they do not use bass “shakers” or vibrator motors to emulate bass, as do products from Woojer, Subpac, Basspac, and Backbeat. These products do not use acoustic exciters, they use rotating magnets or “vibrators” that only emulate sonic frequencies and often have a “lag” effect from this approach. They are not mounted on a wearable frame, nor worn around the neck, and do not stay in position without straps. They only offer bass emulations, rather than actual low-frequency speaker output and they do not offer an integrated full range sound option. In the present systems, in contrast, acoustic energy is transferred directly into the body mass of the user using off-the shelf “exciter” speaker modules (novel use) that are normally used for hifi DML (distributed mode loudspeakers) speaker builds. This results in a zero-lag haptic or “felt” response to the lower frequencies of the music or sound being played that is created from the vibrational movements of the exciter speakers and their accompanying acoustical energy.

The combined weight above the exciters (from the mass of the batteries and canisters) applies downward pressure to the novel chest-contact plates, which are sloped to better contact the user's upper chest cavity area. A ball joint at each collar arm end of the wearable frame allows further articulation control, to allow for precise adjustments to the angle-of attack of the chest contact plates for better effect for each user.

A deluxe model features two separate volume controls for each of the two sonic technologies, and can be adjusted in real time to the user's preference, depending on how much audio volume they prefer, as well as to how much they want to ‘feel’ the music or sounds. The collar-like frame is designed for comfortable use while standing, sitting, or reclining back, and features an optional activity-strap that further secures the device for dancing, biking, or other movement activities. Connectivity is via standard Bluetooth or 3.5 mm auxiliary “mini jack” input port. A 3.5 mm output port allows for the wired use of an optional hand-held canister for more targeted haptics, or for use with headphones or headsets.

In contrast, sound collars from Sony, Bose, & Kove Konvex are all optimized for comfort and small size which requires them to direct sound upwards from below the ear. The human hearing system and our internal processing of sound is aligned in a forward-facing manner (see https://tinyurl.com/earfaqs), and these designs do not leverage this phenomenon. They also do not have haptic response or separate low-frequency audio drivers and controls, nor adjustable chest contact plates for low frequencies. They do not emulate the experience of a soundstage in front of you, and do not have wired inputs/outputs, or an optional hand-held excited module for additional haptic response.

The haptic sensations are experienced via low-frequency (<700 hz) acoustic energy transferred directly into the body mass of the upper chest area, using off-the shelf “exciter” speaker modules that are normally used for hifi DML (Distributed Mode Loudspeakers) speaker builds. The secondary audio modality features a zero-lag haptic or “felt” response to the lower frequencies of the music or sound being played that is created from the vibrational movements of the exciter speakers and their accompanying acoustical energy.

Each pair of primary sound speakers and secondary sound exciters is desirably combined and rigidly housed into a single canister unit. The canister units are preferably fixed with respect one another a space lateral distance apart via a suspension frame such as a collar that goes around behind the wearer's neck. When the wearer is standing, the combined weight above the exciters (from the mass of the twin batteries and full range speaker canisters) applies downward pressure to the novel chest-contact plates, which are sloped to better contact the user's upper-chest cavity area. A ball joint at each collar arm end allows further articulation control, to allow for precise adjustments to the angle-of attack of the chest contact plates for better effect for each user.

The deluxe model portable personal audio frame features two separate volume controls for each of the two sonic technologies, and can be adjusted in real time to the user's preference, based on how much volume they prefer, as well as to how much they want to ‘feel’ the music or sounds. The collar is designed for comfortable use while standing, sitting, or reclining back, and features an optional activity-strap that further secures the device for dancing, biking, or other movement activities.

Connectivity is via standard Bluetooth or 3.5 mm auxiliary “mini jack” input port. A mono 3.5 mm output port allows for the wired use of an optional hand-held exciter-only canister for more targeted haptics that can be felt beyond just the user's upper chest area. This hand-held low-frequency exciter canister can also connect separately to a media player via a separate Bluetooth wireless connection.

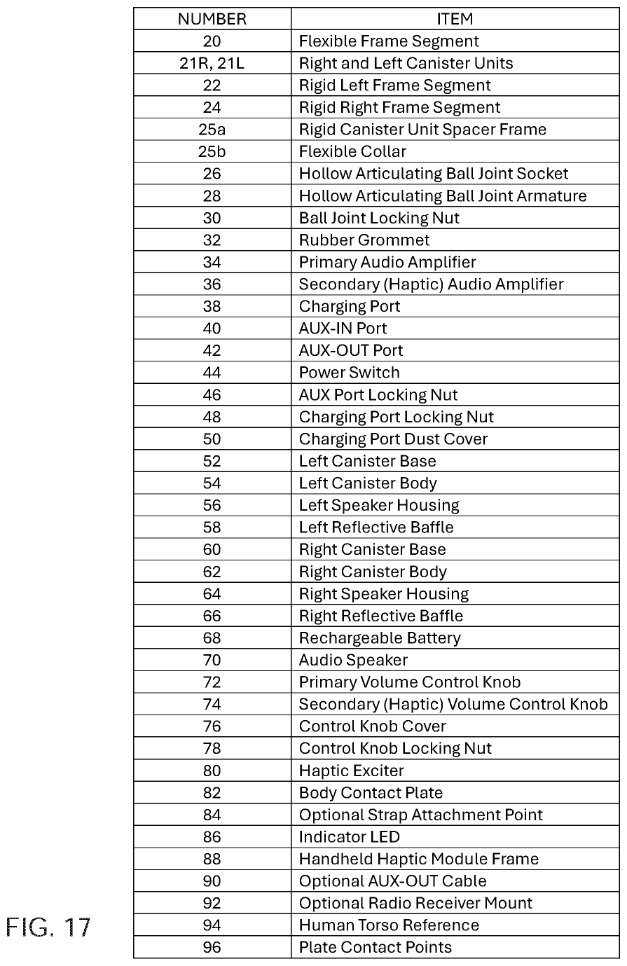

The attached drawings include reference numbers corresponding to the parts list in FIG. 17.

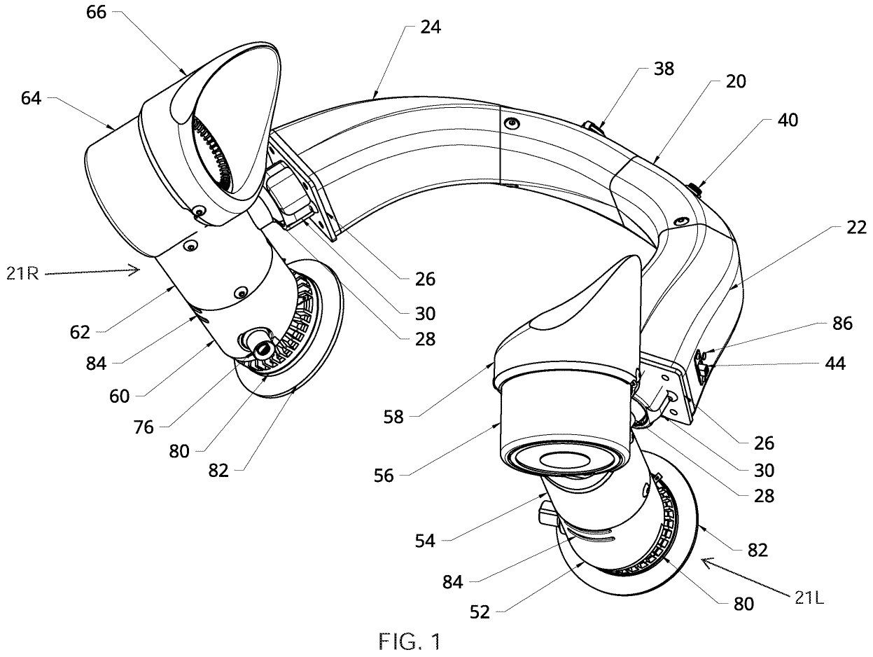

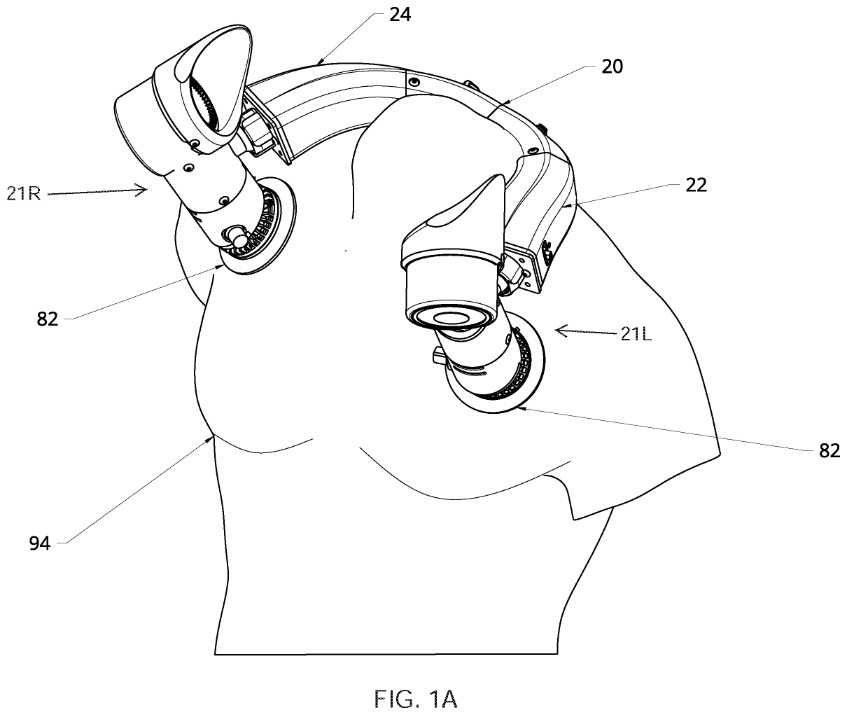

FIG. 1 shows the main frontal/side aspect of a deluxe model of the personal audio frame showing a collar in the form of a neck frame assembly 20, 22, 24 that wraps around behind a person's neck and a pair of canister units-a right-hand speaker-exciter canister unit 21R and a left-hand speaker-exciter canister unit 21L (from the wearer's perspective). FIG. 1A schematically illustrates a human figure using the personal audio frame. The deluxe model features full range open-air speakers, whereas a smaller version in development will shrink the overall canister and frame design by 30%, but maintain the targeted placement of the speakers and body-contact plates.

The frame assembly 20, 22, 24 suspends the speaker-exciter canister units 21R, 21L by gravity in front of the wearer with haptic body contact plates 82 in contact with the wearer's upper chest. Men have a larger average neck circumference (around 15.2 in/38.7 cm) than women (around 13.1 in/33.3 cm), and the frame assembly 20, 22, 24 may be provided in one universal size-adjustable configuration or several different sizes (e.g., S, M, L, XL, etc.). The deluxe speaker-exciter canister units 21R, 21L may be between about 6-9 in (15-23 cm) in length, such as 7.5 in (19 cm), and weigh between about 0.5-1.0 lbs, for instance 0.7 lbs. A smaller version contemplated will shrink the overall canister and frame assembly design by 30%, but maintain the targeted placement of the speakers and body-contact plates 82.

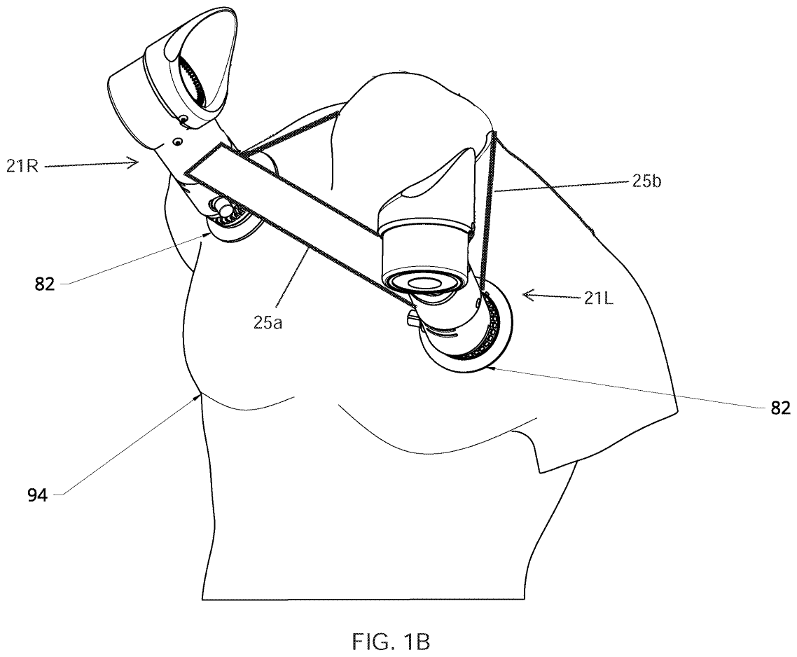

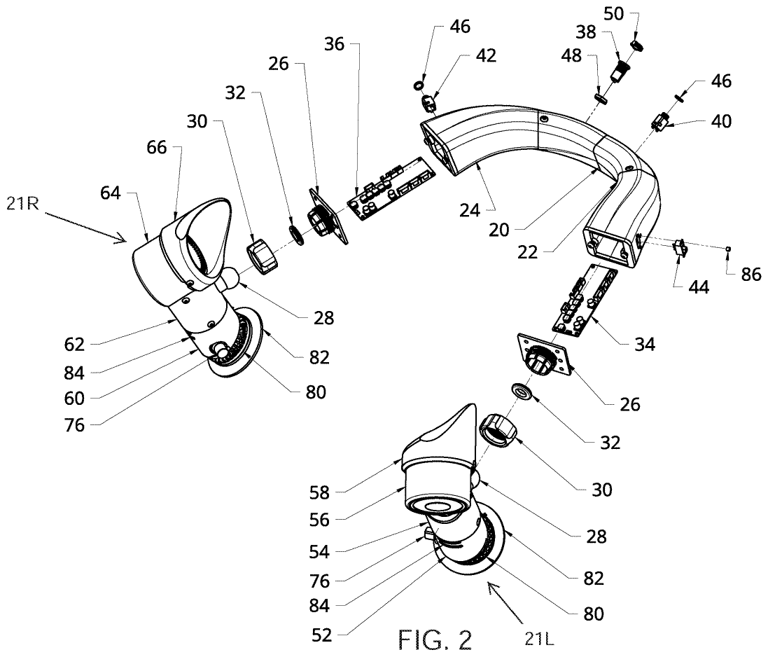

FIG. 2 shows an exploded view of the deluxe model of the personal audio frame, included the internal amplifiers, batteries, and articulating ball joints. It should be understood that the personal audio frame comprises primarily the two canister units 21R, 21L which are held in place by a frame assembly including a flexible central frame segment 20, a rigid left frame segment 22, and a rigid right frame segment 24. Articulating ball joint socket 26 and armature (ball) 28 combinations are disposed between the terminal ends of the left and right frame segments 22, 24 and the canister units 21R, 21L. The combination of the flexible central frame segment 20 and the ball joint connections facilitates adjustability of the positions and angles of the canister units 21R, 21L.

The hollow articulating ball joint socket 26 engages a hollow articulating ball joint armature 28 fixed to the canister units 21R, 21L, and is secured by a ball joint locking nut 30. A rubber grommet 32 provides a moisture barrier to protect electronics housed in the rigid left and right frame segments 22, 24. For instance, a primary audio amplifier 34 may be located in the left frame segment 22 while a secondary (haptic) audio amplifier 36 may be positioned in the right frame segment 24.

Various other electronic connections and ports are seen in FIG. 2, such as a charging port 38, an AUX-IN Port 40, an AUX-OUT Port 42, and a power switch 44. Secondary hardware is also shown, including an AUX Port Locking Nut 46, a charging port locking nut 48, and a charging port dust cover 50.

The left canister unit 21L comprises a left canister base 52, a left canister body 54, a left speaker housing 56, and a left reflective baffle 58. The right canister unit 21R likewise has a right canister base 60, a right canister body 62, a right speaker housing 64, and a right reflective baffle 66. The baffles 58, 66 are positioned on an outer side of the speaker housings 56, 64 and help channel and focus the sound waves from the speakers in the canister units 21R, 21L toward the wearer's ears, and also reduce sound spillage to the sides which might be bothersome to people nearby.

Although the illustrated embodiment shows a frame assembly in the form of a collar that goes around the back of a person's neck, other friend assemblies which holds the dual speaker-exciter canister units 21R, 21L in the optimum position are contemplated. For example, substituting a strap or flexible cord for the collar-type frame assembly and firmly connecting the canister units 21R, 21L together across the front of the person's chest is another option. FIG. 1B schematically shows an alternative rigid support frame 25a and flexible cord or strap 25b supporting the canister units 21R, 21L. By suspending the canister units 21R, 21L from a collar or cord around the wearer's neck enables the weight of the units 21R, 21L to rest on the upper chest area. However, if the wearer is lying down, a collar or cord around the wearer's neck would not even be needed. For example, the two canister units 21R, 21L could be firmly connected together in a spaced apart arrangement for placement on the wearer's chest, with a cord or strap passing under the arms and attached around the backside of the wearer holding the assembly from falling off the chest. In short, the personal audio frame requires the two canister units 21R, 21L and some sort of support frame which holds the units in a desirable position on the wearer's upper chest with the audio speaker component directed at the wearer's ears.

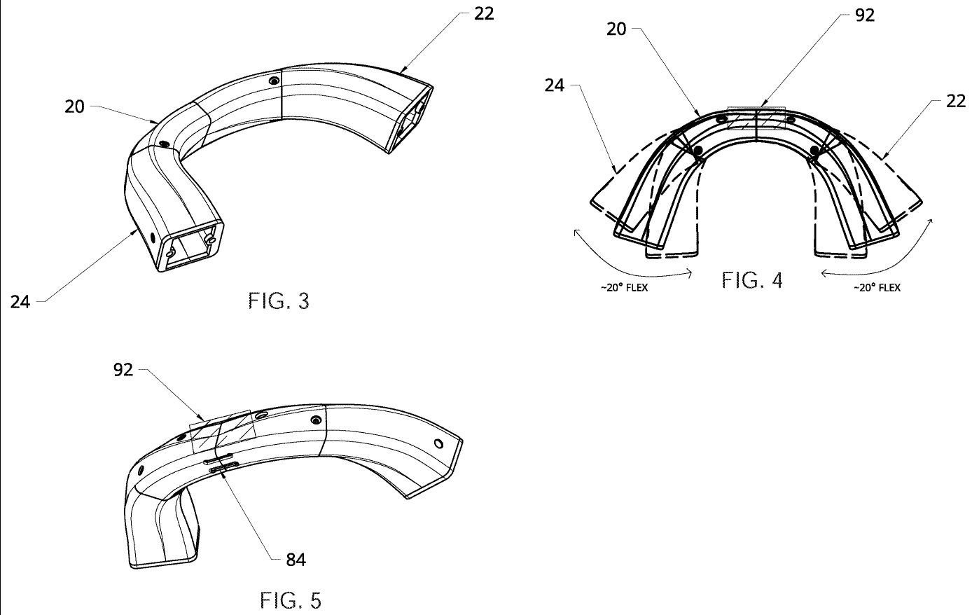

FIGS. 3-5 show the frame assembly 20, 22, 24 from multiple angles and describes the flexible nature of the center segment 20, that allows for a much more comfortable fit. This flexible movement is important for the comfort of the personal audio frame and allows the user to move their upper body more freely, while still maintaining good contact with the haptic body contact plates 82. Also shown is the rear connection point 84 for attachment of an optional activity strap (not shown). The strap is not mandatory for stable use of the personal audio frame while relaxing, but it is recommended for movement activities, such as dancing or bicycling. Additionally, besides the internal Bluetooth connectivity, the personal audio frame features the ability to work with UHF type, FM type, or other auxiliary receivers for when groups of users want to hear and feel the same audio content together. An attachment point 92 on the back of the frame for an optional radio receiver is shown in this diagram as well.

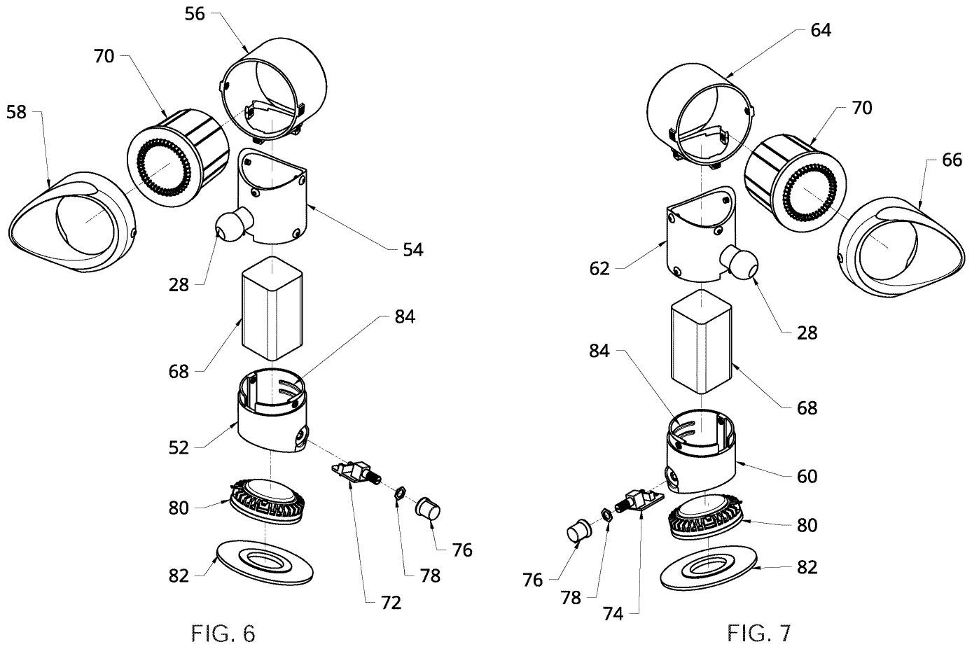

FIGS. 6-7 show an exploded view of the components of the left and right-side dual speaker-exciter canister units 21R, 21L, including the full range speakers, batteries and exciters. Optionally, full-range sub-woofer speakers will substitute the use of exciters for haptic response in certain future designs.

Each canister unit 21R, 21L has an audio speaker 70 on an upper end, and a haptic exciter 80 on a lower end, connected by various housing and actuation/battery components as indicated by the parts list of FIG. 14. The audio speakers 70 are preferably full-range response speakers that are forward-facing as opposed to omnidirectional. Baffles 58, 66 may be rotated to help direct the sound from the speakers 70 to the wearer's ears. The baffles 58, 66 also help restrict lateral sound leakage from the speakers 70 to reduce the effect on nearby listeners. A minimum weight of each of the canister units 21R, 21L is around 0.5-1.0 lbs to provide enough weight from gravity to press against the upper chest region and transmit sound energy from the exciters 80 through the body contact plates 82 to the wearer. The exciters 80 produce mono or single channel sound so that they vibrate in sync for maximum effect on the user.

FIGS. 6-7 also illustrate a rechargeable battery 68 that fits in each canister unit 21R, 21L, as well as a primary volume control knob 72 on the right unit and a secondary (haptic) volume control knob 74 on the left unit. Secondary hardware for each canister unit 21R, 21L is also shown, including a control knob cover 76, a control knob locking nut 78, a haptic exciter 80, a body contact plate 82, and an optional strap attachment point 84.

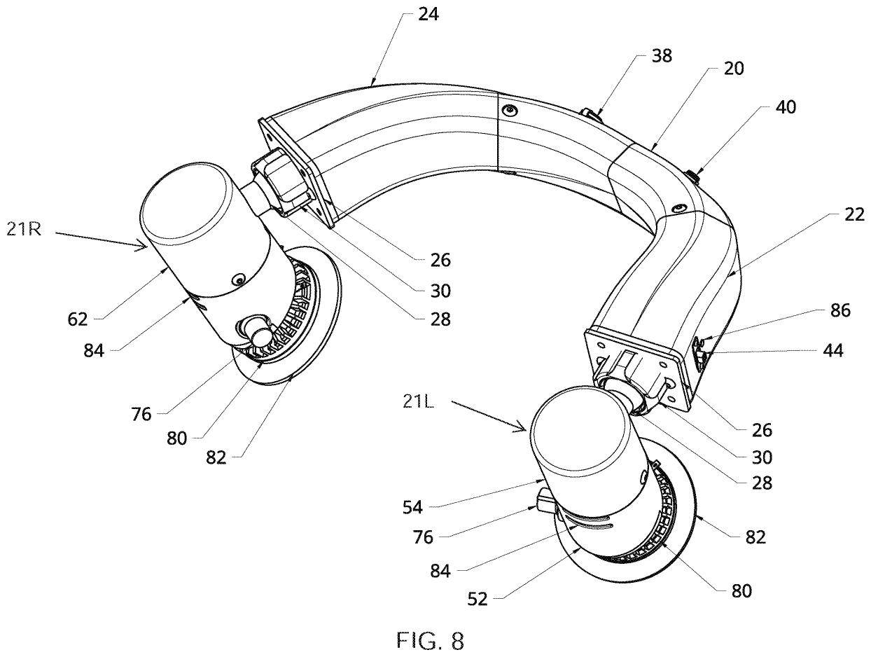

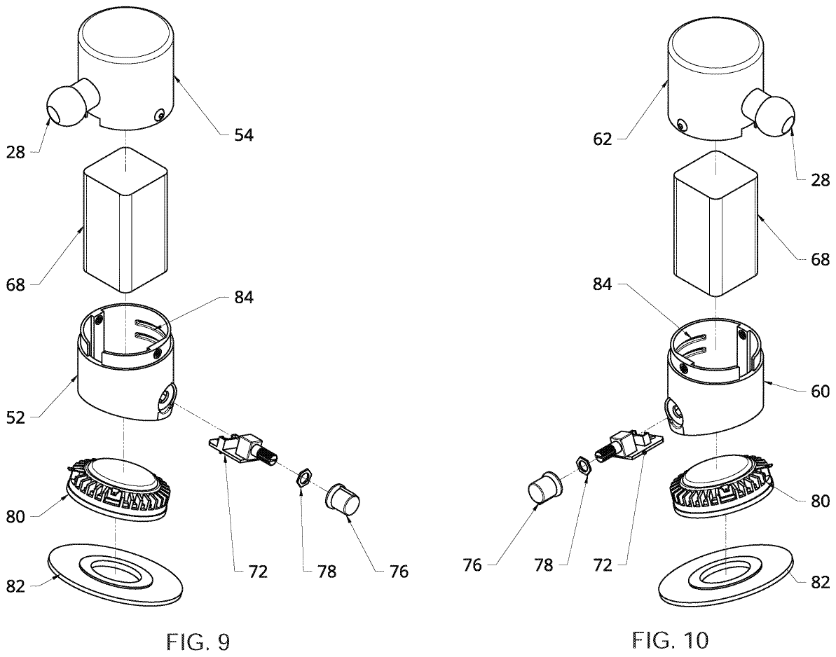

FIG. 8 shows the main frontal/side aspect of an alternative “basic” portable personal audio frame, and FIGS. 9-10 show an exploded view of left and right-side canister towers and components of the basic frame, including batteries and exciters. The basic model frame again has a collar in the form of a frame assembly 20, 22, 24 that wraps around behind a person's neck and a pair of canister units 21R, 21L. However, instead of dual speaker-exciter canister units, the canister units 21R, 21L only have lower haptic exciters 80. The basic model is designed for use with headphones, headsets, or external speakers (not shown). The basic exciter canister units 21R, 21L may be between about 4-6 in (10-15 cm) in length, such as 5 in (13 cm), and weigh between about 0.4-0.6 lbs, for instance 0.5 lbs.

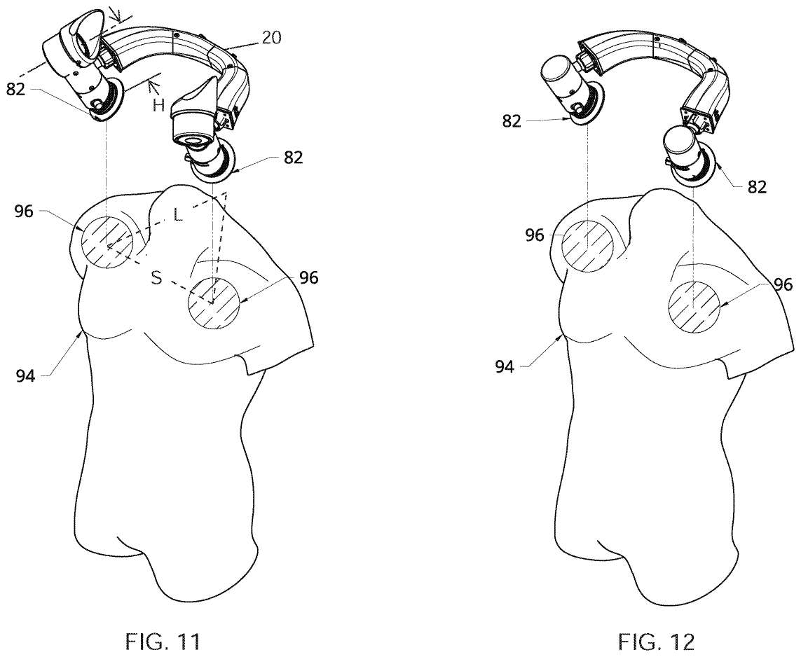

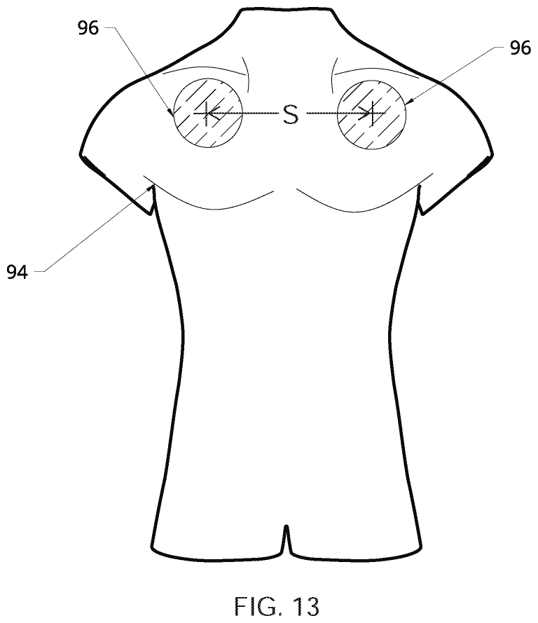

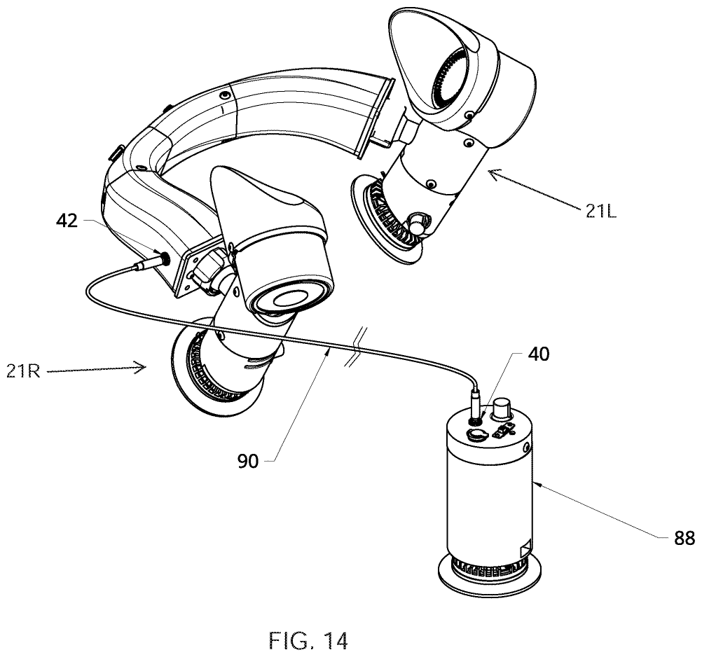

FIGS. 11-12 schematically illustrates the targeted areas 96 of the upper chest on a torso 94 for best haptic response from the secondary low frequency audio for both the deluxe and basic frame models. This is just below the collarbone of the user so that the upper pectorals engage with the exciters or sub-woofers. A lateral spacing S is shown in FIGS. 11 and 13 to indicate a desired spacing between the centers of the body contact plates 82, or lower end of the canister units 21R, 21L. The lateral spacing S is desirably between about 7-11 in (~18-28 cm), though of course this can be adjusted smaller or larger depending on the intended user. For adults, the lateral spacing S is typically between 10-11 in (~25-28 cm), with smaller spacings potentially being useful for children.

FIG. 11 also indicates a length dimension L drawn between the apex at the center of the central frame segment 20 when it is resting behind a wearer's neck, and the center points of the body contact plates 82 when they are placed on the patient's upper chest. Lines drawn between these points and the targeted areas 96 of the upper chest form a triangle, as indicated. In a preferred embodiment, the triangle is equilateral such that the lateral spacing S and length dimensions L are all between 7-11 in, or 10-11 in for adults. Furthermore, a height H is shown indicating the height of one of the canister units 21R, 21L. As indicated above, the deluxe speaker-exciter canister units 21R, 21L may be between about 6-9 in (15-23 cm) in length (as measured between the contact plates and the central axis of the upper speaker), and the basic exciter canister towers may be between about 4-6 in (10-15 cm) in length, which are equal to the height H of each. The total canister unit length may be another 1.5 inches larger for the deluxe speaker-exciter canister units 21R, 21L.

The height of the speaker canister units 21R, 21L in conjunction with the angle of the speakers 70 directs the sound waves (along the central axis of the upper speaker) toward each of the wearer's ears. Generally conical sound wave patterns are emitted from the speakers 70 directed toward the wearer's ears. Before these conical sound wave patterns disperse, they contact the wearer's ears for maximum sound reception. If the wearer turns his or her head, the ears move out of the center of these conical sound wave patterns, much decreasing the overall sound heard. Furthermore, because the speakers 70 direct the sound directly at the ears, and of course helped by the sound energy from the exciters 80 through the body contact plates 82, the volume does not have to be turned up overly loud for excellent sound results, which consequently reduces the ambient sound heard by neighbors.

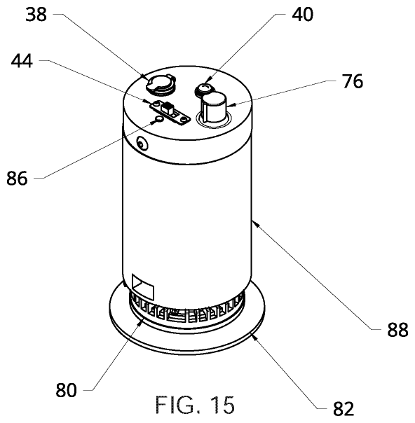

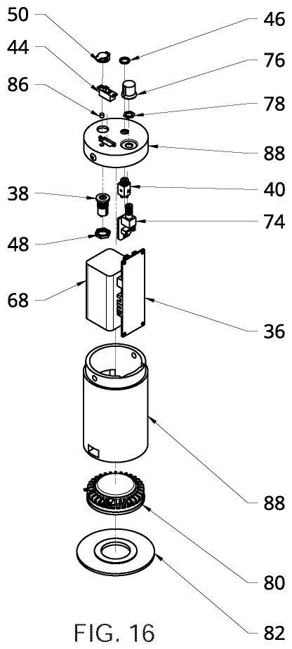

FIG. 14 shows an optional hand-held haptic module similar in design to the lower section of a dual speaker-exciter canister 21L or 21R, though it has a flat base and contact plate 82 instead of a sloped one. FIG. 15 shows a close up of the optional hand-held haptic module, and FIG. 16 shows an exploded view of the optional hand-held module and corresponding components. The hand-held exciter canister units 21R, 21L may be between about 6-7 in (15-18 cm) in length, such as 6.3 in (16 cm), and weigh between about 0.6-0.8 lbs, for instance 0.7 lbs. The hand-held exciter canister units 21R, 21L also have an indicator LED 86, a handheld haptic module frame 88, and an optional AUX-OUT cable 90 to plug into the main unit. The handheld haptic module 88 is connected to one of the speaker-exciter canister units 21L or 21R via the cable 90 or wirelessly for auxiliary customizable response.

Like the secondary haptic system on the deluxe frame, the hand-held module offers the same low frequency (<700 hz) haptic response in a synchronized fashion. This personal audio frame allows someone wearing the frame to also experience a haptic response to the music or sound on areas of the body besides the upper chest. That is, this module is designed for targeted hand held use on the user's body beyond the user's upper chest area. It does not need a full range speaker on the top, as the two speakers on the frame will already be in optimal position to the user's outer ear, or with the basic model they will be using headphones, a headset, or external speakers for the primary sound. This module has its own Bluetooth connection for working in twin connect mode with certain cellular phones (such as current Samsung phones) that can connect to two different Bluetooth devices simultaneously. Other phone companies are expected to follow Samsung's lead and also offer this twin connection in the near future. For users who need a wired-connection, this module has an AUX-IN port for cabled use as well; and this is shown here too. Optionally, a full-range sub-woofer speaker will substitute the use of an exciter for haptic response in certain future designs.

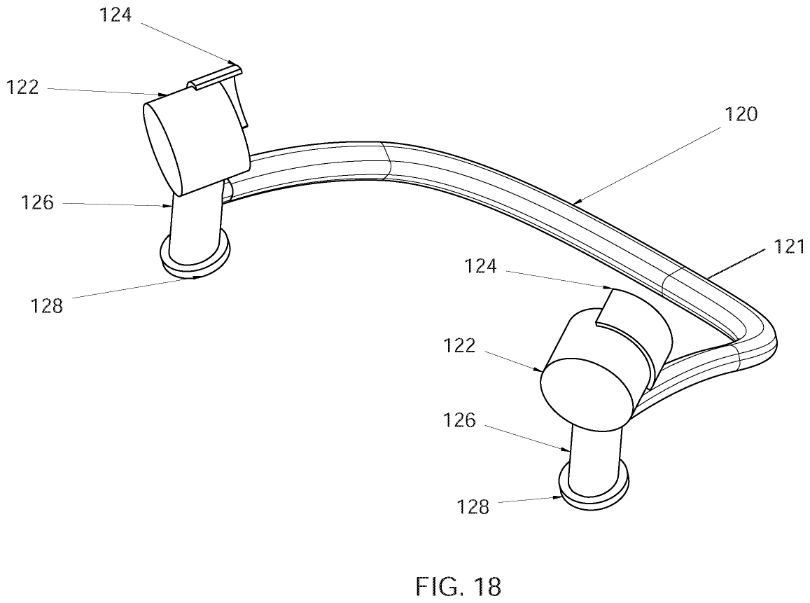

FIGS. 18-24 illustrate an alternative portable personal audio frame 120 which has a much smaller version of the speaker frames still with chest contact pads, and optional lower exciters. The bass from the speakers would still be felt acoustically through contact with the body. A narrower neck frame 121 increases comfort when used while reclining, but the frame assembly described above could also be used.

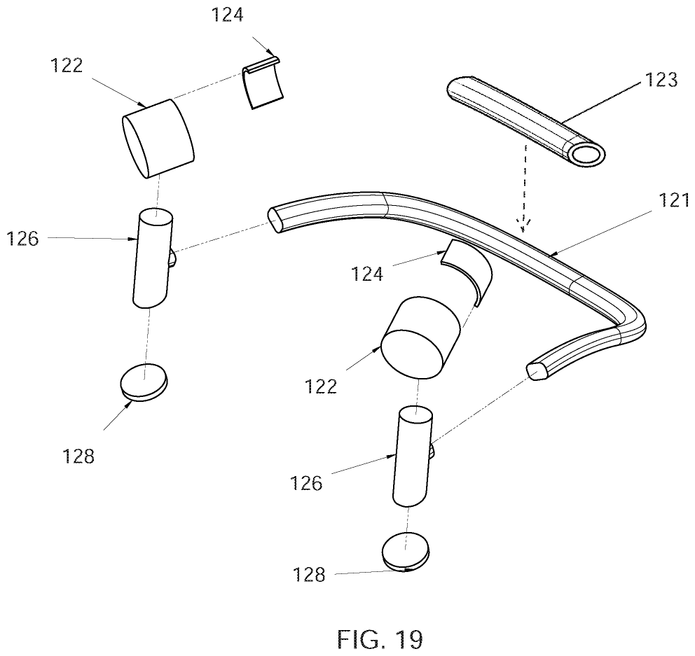

FIG. 18 is a perspective view of the alternative portable personal audio frame 120 having left and right-side speaker canister towers but may not have exciters, and FIG. 19 is an exploded perspective view thereof. The neck frame 121 curves in a substantial U-shape to fit around a wearer's neck, and speakers 122 are affixed to the free ends thereof. Speakers 122 are mounted atop canister bodies 126 canister bodies 126 each of which has a body contact plate 128 at a lower end. The body contact plates 128 are slightly wider than the canister bodies 26 and adapted to ergonomically fit against a wearer's chest. As mentioned, there may be no exciter coupled with the speaker 122, though the vibratory response of the speaker will transmit through the canister body 126 and plate 128 to provide some measure of tactile base vibration to the wearer's chest. A soft or padded sleeve 123 may be slid on to the neck frame 121 for ergonomic comfort. In some embodiments of this smaller, thinner frame, small exciters may be included at the lower end of the canister towers.

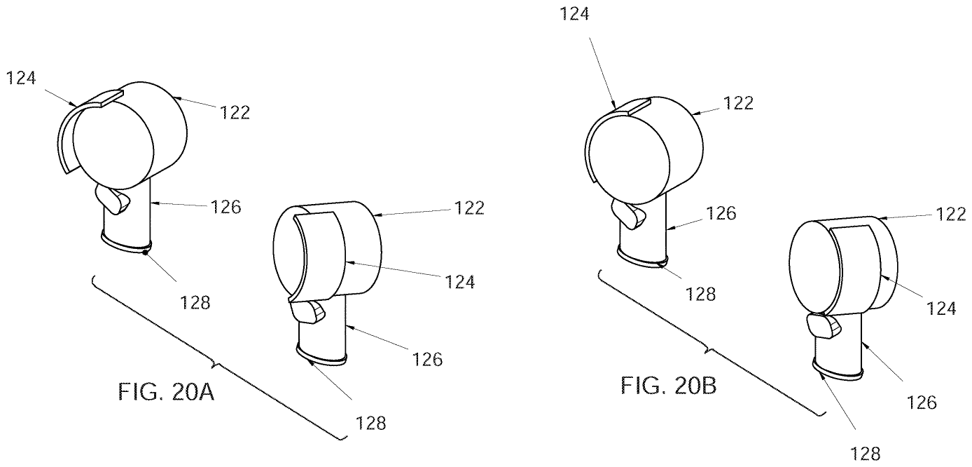

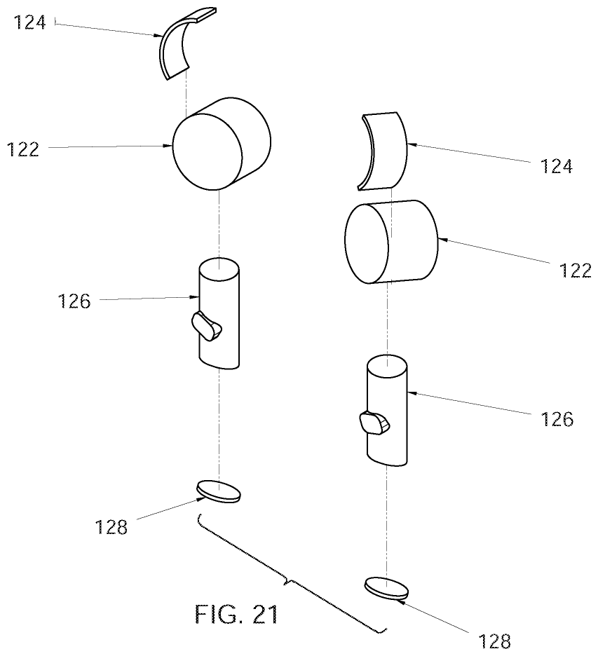

FIG. 20A is a perspective view of the two speaker canister towers of the alternative audio frame 120 of FIG. 18 showing a pair of sound baffles 124 extended, and FIG. 20B shows the baffles retracted. FIG. 21 is an exploded perspective view of the two speaker canister towers. Although not shown in detail, the baffles 124 are raised to slide back and forth along the axis of the generally cylindrical speakers 122 on the outer surface thereof. The baffles 124 are positioned on an outer side of the speakers 122 and, when extended, help reflect or focus the sound waves toward the user's ears, as will be shown. This is particularly useful during activities such as biking to better focus the sound. If not needed, the baffles 124 can be retracted to reduce the overall size of the speaker canister tower.

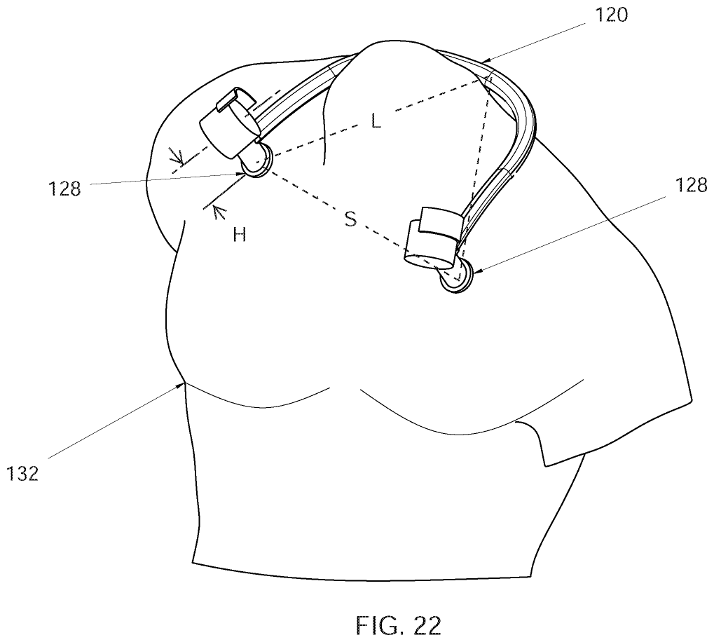

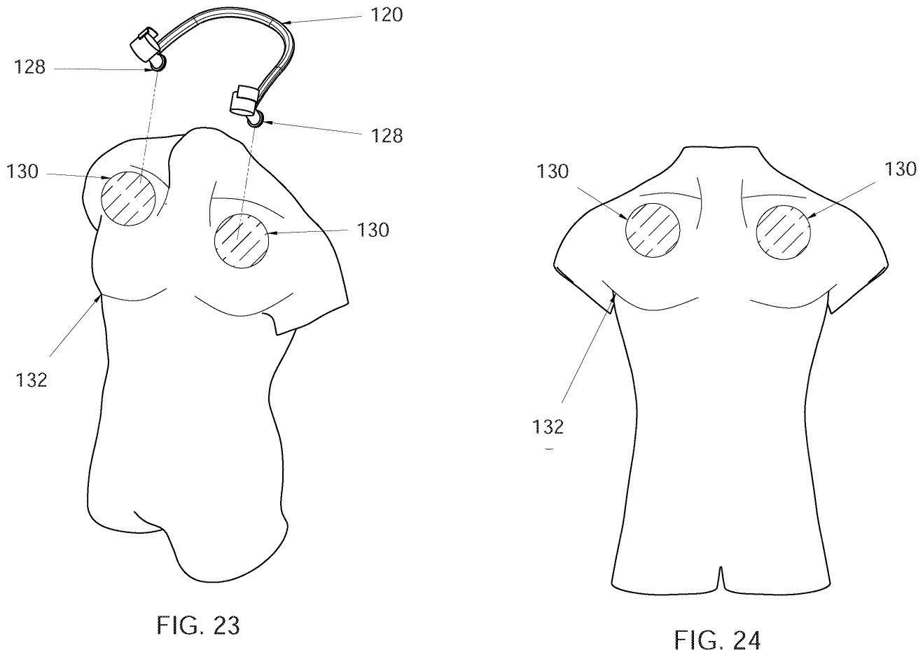

FIG. 22 is a perspective view of the alternative audio frame 120 of FIG. 18 as positioned on a wearer, and FIGS. 23 and 24 schematically illustrate the targeted area of the upper chest for best audio reception from the speakers. More specifically, circular plate contact areas 130 are indicated on the upper chest of a torso 132. The body contact plates 128 at the lower ends of the speaker canister towers ideally rest somewhere within these plate contact areas 134 best sound to the wearer's ears.

As explained above, the lateral spacing S between the centers of the contact plates 128 is desirably between about 7-11 in (~18-28 cm), or 10-11 in (~25-28 cm) for adults. FIG. 22 also indicates a length dimension L drawn between the apex at the center of the central frame segment 120 when it is resting behind a wearer's neck, and the center points of the body contact plates 128 when they are placed on the patient's upper chest. Lines drawn between these points and the targeted areas 130 of the upper chest form a triangle, as indicated. The triangle may be equilateral such that the lateral spacing S and length dimensions L are all between 7-11 in, or 10-11 in for adults. Furthermore, a height H is shown indicating the height of one of the canister towers. The canister towers may be between about 4-6 in (10-15 cm) in length as measured between the contact plates and the central axis of the upper speaker, which is equal to the height H. The total canister unit length may be another 1.5 inches larger. A minimum weight of each of the canister towers is around 0.5-1.0 lbs to provide enough weight from gravity to press against the upper chest region if the towers have exciters, but may be less if there are only speakers.

The height of the speaker canister towers in conjunction with the angle of the speakers 122 directs the sound waves toward each of the wearer's ears. As explained above, generally conical sound wave patterns are emitted from the speakers 122 directed toward the wearer's ears for maximum sound reception. If the wearer turns his or her head, the ears move out of the center of these conical sound wave patterns, much decreasing the overall sound heard. Furthermore, the directed sound effect means that the volume does not have to be turned up overly loud for excellent sound results, which consequently reduces the ambient sound heard by neighbors.

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

Those skilled in the art will appreciate that various changes and modifications may be made to the preferred embodiments, the invention in its broader aspects is not limited to the specific details, representative devices, and illustrative examples shown and described.

It is claimed:

1. A personal audio frame for a person, comprising:
a pair of dual speaker-exciter canister units having a haptic exciter speaker at a lower end, and a directed audio speaker at an upper end, the canister units having power and amplification circuitry for separately activating the haptic exciter speaker and directed audio speaker; and
a frame assembly firmly holding the canister units a spaced lateral distance apart, the frame assembly enabling placement of the pair of canister units on a person's upper chest with the directed audio speakers pointed toward the person's ears.

2. The personal audio frame of claim 1, wherein the frame assembly comprises a collar sized to pass behind the person's neck and connected to each of the canister units.

3. The personal audio frame of claim 2, further including ball swivel joints connected between terminal ends of the collar and each of the canister units.

4. The personal audio frame of claim 2, wherein the frame assembly comprises a flexible central segment in between rigid left and right segments.

5. The personal audio frame of claim 1, wherein the frame assembly comprises a rigid support frame connected directly between the canister units and a flexible cord or strap sized to pass behind the person's neck and connected to each of the canister units.

6. The personal audio frame of claim 1, further including baffles attached to each of the directed audio speakers on an outer side thereof that help direct and focus sound from the speakers to the person's ears.

7. The personal audio frame of claim 6, wherein the baffles are retractable and extendable.

8. The personal audio frame of claim 1, further including two separate volume controls, one for the haptic exciter speakers and second for the directed audio speakers.

9. The personal audio frame of claim 1, further including flat body contact plates at the lower end of each of the canister units that extend outward wider than the canister units.

10. The personal audio frame of claim 1, wherein the frame assembly holds the canister units apart at a lateral spacing S of between about 7-11 in (~18-28 cm).

11. The personal audio frame of claim 1, wherein the canister units are each about 4-6 in (10-15 cm) in length as measured between a lower body contact plate at a lower end of the canister unit and a central axis of the directed audio speaker.

12. The personal audio frame of claim 1, further including a handheld haptic module having a haptic exciter speaker at a lower end and connected to one of the speaker-exciter canister units for auxiliary customizable response.

13. A personal audio frame for a person, comprising:
a pair of canister units having a haptic exciter speaker at a lower end, the canister units having power and amplification circuitry for activating the haptic exciter speakers; and
a frame assembly comprising a collar sized to pass behind the person's neck and connected to each of the canister units and firmly holding the canister units a spaced lateral distance apart, the frame assembly enabling placement of the pair of canister units on a person's upper chest.

14. The personal audio frame of claim 13, wherein the frame assembly comprises a collar sized to pass behind the person's neck and connected to each of the canister units.

15. The personal audio frame of claim 14, further including ball swivel joints connected between terminal ends of the collar and each of the canister units.

16. The personal audio frame of claim 14, wherein the frame assembly comprises a flexible central segment in between rigid left and right segments.

17. The personal audio frame of claim 13, wherein the frame assembly holds the canister units apart at a lateral spacing S of between about 7-11 in (~18-28 cm).

18. A personal audio frame for a person, comprising:
a pair of canister units having a directed audio speaker at an upper end, the canister units having power and amplification circuitry for activating the directed audio speakers; and
a frame assembly comprising a collar sized to pass behind the person's neck and connected to each of the canister units and firmly holding the canister units a spaced lateral distance apart, the frame assembly enabling placement of the pair of canister units on a person's upper chest.

19. The personal audio frame of claim 18, wherein the frame assembly comprises a collar sized to pass behind the person's neck and connected to each of the canister units.

20. The personal audio frame of claim 19, further including ball swivel joints connected between terminal ends of the collar and each of the canister units.

21. The personal audio frame of claim 19, wherein the frame assembly comprises a flexible central segment in between rigid left and right segments.

22. The personal audio frame of claim 18, wherein the frame assembly holds the canister units apart at a lateral spacing S of between about 7-11 in (~18-28 cm).
